(19) United States
(12) Patent Application Publication
(10) Pub. No.: US 2014/0338941 A1
(43) Pub. Date: Nov. 20, 2014

(54) HAND POWER TOOL COMPRISING A SPINDLE LOCK DEVICE

(71) Applicant: Robert Bosch GmbH, Stuttgart (DE)

(72) Inventors: Gai Sheng Koh, Air Itam (MY); Sim Teik Yeoh, Gelugor (MY)

(73) Assignee: Robert Bosch GmbH, Stuttgart (DE)

(21) Appl. No.: 14/267,652

(22) Filed: May 1, 2014

(30) Foreign Application Priority Data
May 17, 2013 (DE) 10 2013 209 173.7

(51) Int. Cl. B25D 11/10; B25B 21/02; B25D 16/00

(52) U.S. Cl. CPC B25D 11/10; B25D 16/006; B25B 21/02
USPC 173/48

(57) ABSTRACT

A hand power tool includes a drive spindle, a mechanical impact mechanism, and a spindle lock device. The mechanical impact mechanism has an impact body having at least two drive cams. The spindle lock device has a spindle roller carrier disposed on the drive spindle. At least two spindle rollers are disposed on the spindle roller carrier. The spindle lock device is connected via a coupling member to the mechanical impact mechanism. The coupling member is disposed between the impact body and the spindle roller carrier, in the axial direction of the drive spindle. The coupling member is configured to effect rotary driving of the spindle roller carrier, upon rotary driving by the impact body, when the hand power tool is in a normal mode.

This application claims priority under 35 U.S.C. §119 to patent application number DE 10 2013 209 173.7, filed on May 17, 2013 in Germany, the disclosure of which is incorporated herein by reference in its entirety.

### BACKGROUND

The present disclosure relates to a hand power tool, comprising a drive spindle, a mechanical impact mechanism, which has an impact body having at least two drive cams, and comprising a spindle lock device, which has a spindle roller carrier, which is disposed on the drive spindle and on which at least two spindle rollers are disposed.

Such a hand power tool is known from EP 1 847 355 B1, this hand power tool having a mechanical impact mechanism that is provided with an impact body comprising two drive cams. This hand power tool has a spindle lock device, in which a spindle roller carrier provided with two spindle rollers is disposed on a drive spindle, which can be driven in rotation or percussively by the impact body when the hand power tool is in the normal or impact mode. In this case, when the hand power tool is in the normal mode, the impact body, via its two drive cams, transmits a torque to assigned output cams of the spindle roller carrier, which transmits this torque to the drive spindle via assigned driver arms.

A disadvantage of the prior art is that, in the case of such a hand power tool, there is an inefficient transmission of torque from the impact body to the drive spindle via the spindle roller carrier, since the output cams and the driver arms of the spindle roller carrier have differing radii in relation to a longitudinal central axis of the spindle roller carrier.

### SUMMARY

It is therefore an object of the disclosure to provide a new hand power tool, comprising a mechanical impact mechanism and a spindle lock device, with which, in the normal mode, it is possible to achieve an improved transmission of torque from an impact body, assigned to the impact mechanism, to a drive spindle of the hand power tool that is provided with a spindle roller carrier of the spindle lock device.

This problem is solved by a hand power tool, comprising a drive spindle, a mechanical impact mechanism, which has an impact body having at least two drive cams, and comprising a spindle lock device, which has a spindle roller carrier, which is disposed on the drive spindle and on which at least two spindle rollers are disposed. The spindle lock device is connected via a coupling member to the mechanical impact mechanism, which is disposed between the impact body and the spindle roller carrier, in the axial direction of the drive spindle, and which is realized to effect rotary driving of the spindle roller carrier, upon rotary driving by the impact body, when the hand power tool is in the normal mode.

The disclosure thus makes it possible to provide a hand power tool, comprising a mechanical impact mechanism and a spindle lock device, with which, through use of the separate coupling member disposed between the impact body and the spindle roller carrier, it is possible to achieve an improved transmission of torque from the impact body of the impact mechanism to the drive spindle provided with the spindle roller carrier, in the normal mode. Moreover, the use of the separate coupling member does not require any increase in the dimensions of the hand power tool, which can therefore be of a compact configuration.

According to one embodiment, the coupling member has at least two output cams, which are realized to be driven percussively by the drive cams of the impact body when the mechanical impact mechanism is in the impact mode.

Thus, when the hand power tool, or the mechanical impact mechanism, is in the impact mode, percussive driving of the coupling member by the impact body is easily achieved.

Preferably, the coupling member has at least one opening, in which a pin-type driver member, provided on the spindle roller carrier, engages to enable rotary driving of the spindle roller carrier, upon rotary driving of the coupling member by the impact body, when the hand power tool is in the normal mode.

A driving torque that is transmitted from the impact body of the mechanical impact mechanism to the coupling member when the hand power tool is in the normal mode can thus be transmitted in a safe and reliable manner from the coupling member to the spindle roller carrier. In this case, an improved transmission of torque from the impact body to the drive spindle can be achieved, in particular, in that a radius from an assigned longitudinal central axis of the spindle roller carrier to the pin-type carrier member corresponds, at least approximately, to a radius from an assigned longitudinal central axis of the coupling member to the output cams.

Preferably, provided on the coupling member there are at least two drivers, which are disposed on the outer circumference of the spindle roller carrier, to enable at least one of the at least two spindle rollers to be driven, upon rotary driving of the spindle roller carrier by the coupling member, when the hand power tool is in the normal mode.

Thus, when the hand power tool is in the normal mode, uncontrolled blocking of the at least one of the at least two spindle rollers can be prevented in an effective manner.

Preferably, the spindle roller carrier is disposed on the drive spindle in a rotationally fixed manner.

A transmission of torque from the spindle roller carrier to the drive spindle is thus easily achieved.

According to one embodiment, the spindle roller carrier with the at least two spindle rollers is seated so as to be rotationally movable in a blocking member, which is realized to fix the at least two spindle rollers to the spindle roller carrier, in the radial direction of the drive spindle.

The disclosure thus makes it possible to provide a hand power tool in which the spindle rollers are safely and reliably fixed to the spindle roller carrier.

Preferably, on its outer circumference, the spindle roller carrier has an assigned guide curve for each of the at least two spindle rollers.

The spindle rollers can thus be guided along the respectively assigned guide curve, in dependence on the respective operating mode of the hand power tool, i.e. normal or impact mode, in respectively assigned operating positions.

The assigned guide curve is preferably realized to enable at least one spindle roller to be clamped between the spindle roller carrier and the blocking member, when the spindle lock device is in the spindle lock mode.

It is thus easy to achieve blocking of the drive shaft relative to the tool housing of the hand power tool, when the hand power tool, or the spindle lock device, is in the spindle lock mode.

According to one embodiment, the spindle lock device has at least four spindle rollers and, when the spindle lock device is in the spindle lock mode, at least two of the at least four spindle rollers in each case prevent a rotation of the spindle roller carrier relative to the blocking member.

The disclosure thus makes it possible to provide a hand power tool having a robust and stable spindle lock device, with which blocking forces that occur in the spindle lock mode are in each case distributed to at least two spindle rollers, such that overloading of the spindle rollers can be prevented in an effective manner.

The blocking member is preferably annular in form, and connected to a tool housing of the hand power tool in a rotationally fixed manner.

The blocking member can thus be easily fixed in the tool housing.

### BRIEF DESCRIPTION OF THE DRAWINGS

The disclosure is explained in greater detail in the description that follows, with reference to exemplary embodiments represented in the drawings, wherein:

FIG. 1 shows a schematic view of a hand power tool according to the disclosure,

FIG. 2 shows a perspective, exploded view of the drive spindle, the spindle lock device, the output housing portion and the mechanical impact mechanism of FIG. 1,

FIG. 3 shows a sectional view of the spindle lock device from FIGS. 1 and 2, disposed in the hand power tool of FIG. 1, in a non-operative state, as viewed in the direction of arrows III of FIG. 1,

FIG. 4 shows a sectional view of an arrangement comprising the spindle lock device from FIGS. 1 to 3, coupled to the impact body of FIG. 2 via the coupling member of FIG. 2, as viewed in the direction of arrows IV of FIG. 1,

FIG. 5 shows the arrangement of FIG. 4 when the hand power tool of FIG. 1 is in the normal mode, and

FIG. 6 shows the arrangement of FIG. 4 when the hand power tool of FIG. 1 is in the spindle lock mode.

### DETAILED DESCRIPTION

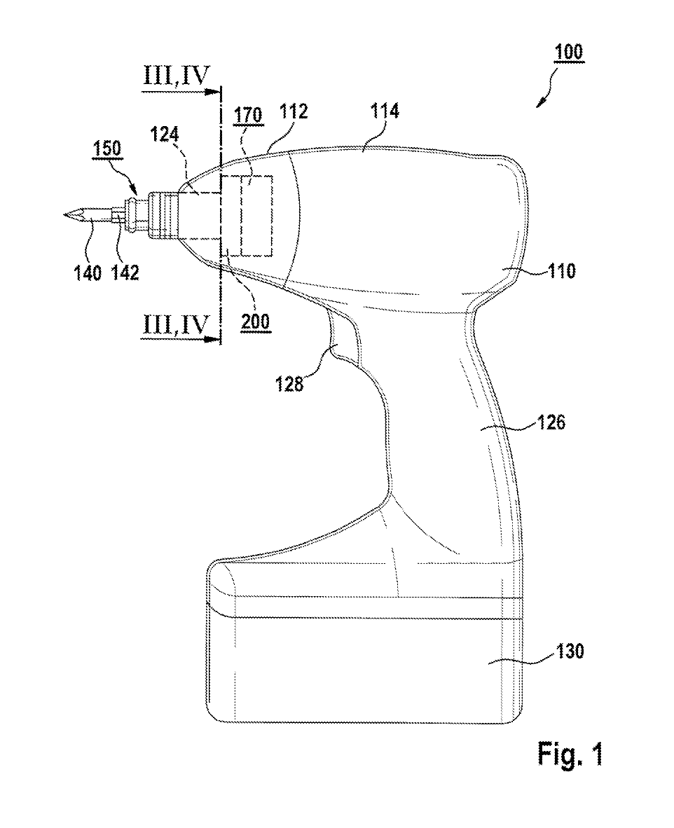

FIG. 1 shows a hand power tool 100, which is provided with a tool receiver 150 and has a tool housing 110 having a handle 126. The tool housing 110 is realized, by way of example, in at least two parts, and has a drive housing portion 114 and an output housing portion 112. The drive housing portion 114 and the output housing portion 112 may likewise each be realized in two parts, e.g. in a shell construction.

According to one embodiment, for the purpose of supplying electrical power independently of a mains power supply, the hand power tool 100 can be connected mechanically and electrically to a battery pack 130 and, by way of illustration, can be actuated, i.e. switched on and off, via a hand switch 128. The hand power tool 100 is realized, by way of example, as a battery-operated rotary impact screwdriver, and has a mechanical impact mechanism 170. The latter, by way of example, is a rotary, or rotational, impact mechanism, which generates percussive-type rotary impulses at high intensity and transmits them to an output shaft 124. It is pointed out, however, that the present disclosure is not limited to battery-powered rotary impact screwdrivers but, rather, may be used with various hand power tools that have mechanical impact mechanisms, in particular rotational, or rotary, impact mechanisms, irrespective of whether the hand power tool can be operated electrically, i.e. independently of a mains power supply, by means of a battery pack, or in dependence on a mains power supply, or non-electrically.

The output shaft 124 is, for example, a drive spindle that is realized to drive a tool receiver 150 and on which the tool receiver 150 is disposed. The latter is realized to receive insert tools, and may be formed on to the drive spindle 124 or connected to the latter as an attachment. Preferably, the tool receiver 150 can be connected both to an insert tool 140 having an external polygonal coupling 142, and to an insert tool having an internal polygonal coupling, e.g. a socket wrench. The insert tool 140, by way of example, is realized as a screwdriver bit having the external polygonal coupling 142 realized, by way of illustration, as a hexagonal coupling, which is disposed in a suitable hexagonal internal receiver of the tool receiver 150. Such a tool receiver and such a screwdriver bit are sufficiently well known from the prior art and do not constitute subject-mater of the present disclosure, such that, to keep the description concise, they are not described in detail here.

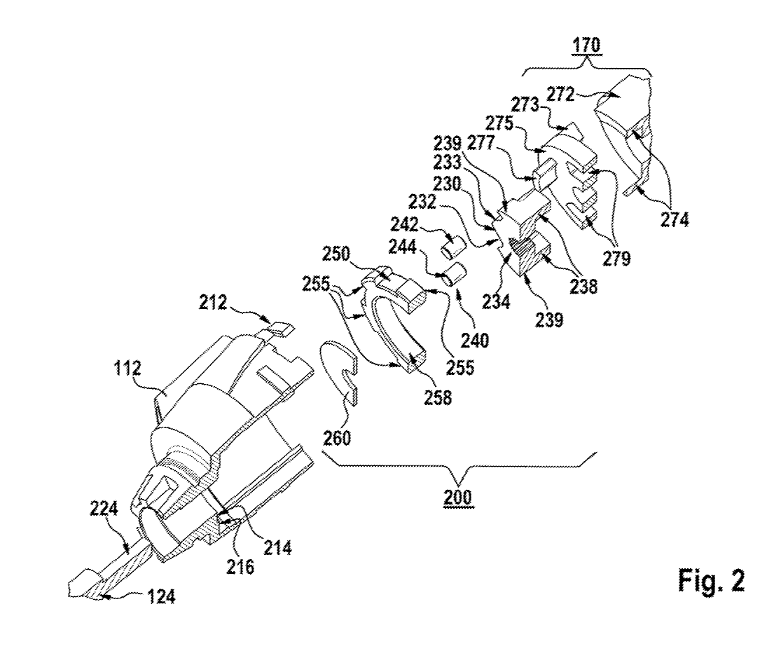

According to one embodiment, a spindle lock device 200, described in greater detail below with reference to FIG. 2, is assigned to the drive spindle 124. This spindle lock device 200 and the mechanical impact mechanism 170 are disposed, by way of illustration, in the output housing portion 112 of the tool housing 110. Disposed in the drive housing portion 114 of the latter there is, for example, a drive motor, and a transmission for driving the mechanical impact mechanism 170, and thus the drive spindle 124. The functioning and structure of a suitable drive motor, or transmission, are sufficiently well known from the prior art, such that, to keep the description concise, they are not described in detail here and, likewise, to simplify the drawing, they are not represented.

The spindle lock device 200 is disposed between the mechanical impact mechanism 170 and the tool receiver 150, in the axial direction of the drive spindle 124, and serves to center and block the drive spindle 124 when the drive motor has been switched off. The functioning of spindle lock devices is sufficiently well known from the prior art, such that, to keep the description concise, the functioning of the spindle lock device 200 is not described in detail here.

FIG. 2 shows the drive spindle 124, the output housing portion 112, the spindle lock device 200 and the mechanical impact mechanism 170 of FIG. 1. The output housing portion 112, by way of illustration, has fastening elements 212 for fastening to the drive housing portion 114 of FIG. 1, and has a first annular shoulder 216, which graduates into a second annular shoulder 214, the annular shoulders 214, 216 being realized in an axial end region of the output housing portion 112 that faces toward the tool receiver 150 of FIG. 1.

The mechanical impact mechanism 170, by way of example, has an impact body 272, which is seated so as to be rotationally movable and longitudinally displaceable, at least partially, in the output housing portion 112, and which has at least two drive cams 274, and is spring loaded in the direction of the drive spindle 124. An exemplary mechanical impact mechanism, by which the mechanical impact mechanism 170 can be realized, is described in DE 20 2006 014 850 U1, to which express reference is made here, and the teaching of which is to be understood to be part of the present description, such that, to keep the description concise, the mechanical impact mechanism 170 need not be described in detail here.

According to one embodiment, the mechanical impact mechanism 170 is connected to the spindle lock device 200 via a coupling member 275. This coupling member 275, by way of illustration, is assigned both to the mechanical impact mechanism 170 and to the spindle lock device 200, and is realized as a separate component disposed between the impact body 272 of the mechanical impact mechanism 170 and a spindle roller carrier 230 of the spindle lock device 200, in the axial direction of the drive spindle 124.

The spindle roller carrier 230 has a central opening 234, is disposed on the drive spindle 124, which engages in the latter by means of a connecting portion 224, and is preferably connected to the drive spindle in a rotationally fixed manner, e.g. by means of a press fit or a form closure connection on the connecting portion 224. Disposed on the spindle roller carrier 230, e.g. on its outer circumference, there are at least two, and preferably four or more, spindle rollers 240, of which only two spindle rollers 242, 244 are shown, by way of example, in FIG. 2. In addition, at least one, and preferably two or more, pin-type driver members 238 are realized on the spindle roller carrier 230. In this case, a radius realized between a radially outwardly directed outer face of at least one pin-type driver member 238 and a longitudinal central axis of the spindle roller carrier 230 preferably corresponds, at least approximately, to a radius realized between a radially inwardly directed inner face of at least one drive cam 274 of the impact body 272 and a longitudinal central axis of the impact body 272.

The pin-type driver members 238 preferably extend at least approximately parallelwise in relation to each other and in each case out from radial extensions 239, provided on the outer circumference of the spindle roller carrier 230, which is at least substantially annular in form, in the direction of the coupling member 275. At least two, and preferably four, guide curves 232, 233 (and 532, 534 in FIG. 4) are realized between the radial extensions 239, on the outer circumference of the spindle roller carrier 230, one guide curve 232, 233 (and 532, 534 in FIG. 4) being assigned to each of the spindle rollers 240.

The coupling member 275 is preferably realized, at least, to effect rotary driving of the spindle roller carrier 230 upon rotary driving by the impact body 272, when the hand power tool 100 of FIG. 1 is in the normal mode. For the purpose of rotary driving by the impact body 272, the coupling member 275 has at least two output cams 273 that, in the normal mode, remain in continuous contact with the drive cams 274 of the impact body 272, such that a rotation of the impact body 272 causes a rotation of the coupling member 275. In addition, the output cams 273 are realized to be driven percussively by the drive cams 274 when the mechanical impact mechanism 170 is in the impact mode. For the purpose of rotary driving of the spindle roller carrier 230, the coupling member 275 has at least one, and by way of illustration, at least two openings 279, in which the pin-type driver members 238 of the spindle roller carrier 230 engage, to enable rotary driving of the spindle roller carrier 230, upon rotary driving of the coupling member 275 by the impact body 272, when the hand power tool 100 of FIG. 1 is in the normal mode.

In addition, provided on the coupling member 275 there are preferably at least two drivers 277 (and 577 in FIG. 4), which are disposed on the outer circumference of the spindle roller carrier 230 and bear, at least portionally, against the guide curves 232, 233 (and 532, 534 in FIG. 4). These drivers 277 (and 577 in FIG. 4) are realized, at least, to enable driving of at least one of the spindle rollers 240 upon rotary driving of the spindle roller carrier 230 by the coupling member 275, when the hand power tool 100 of FIG. 1 is in the normal mode.

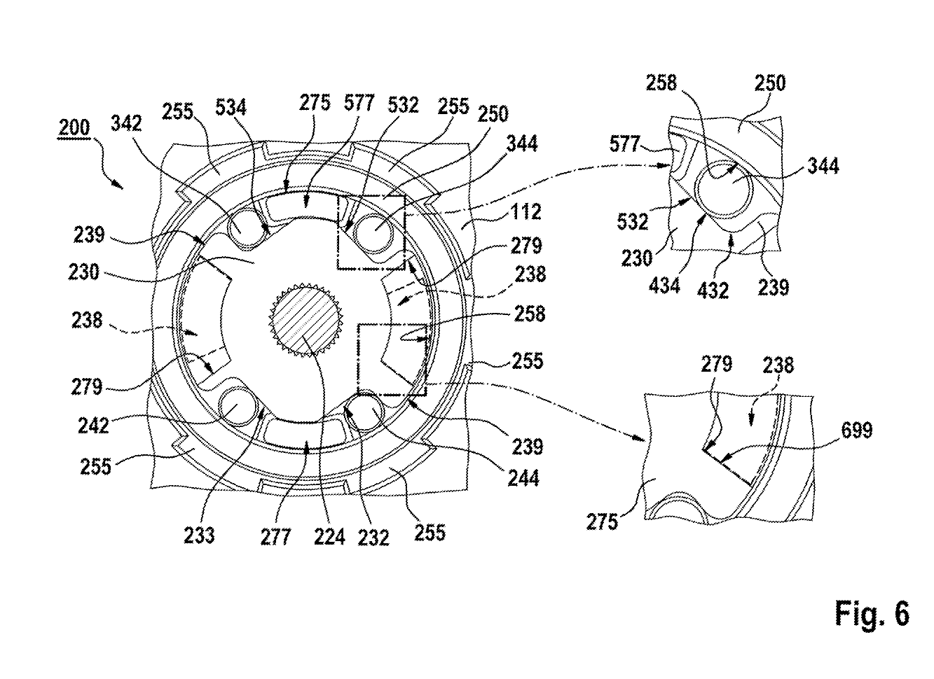

According to one embodiment, the spindle roller carrier 230 with the spindle rollers 240 is seated so as to be rotationally movable in a blocking member 250, which is realized, at least, to fix the spindle rollers 240 to the spindle roller carrier 230, or to the guide curves 232, 233 (and 532, 534 in FIG. 4) thereof, in the radial direction of the drive spindle 124. Each guide curve 232, 233 (and 532, 534 in FIG. 4) in this case is realized to enable at least one of the spindle rollers 240 to be blocked between the spindle roller carrier 230 and an inner circumference 258 of the blocking member 250 when the hand power tool 100 of FIG. 1, or the spindle lock device 200, is in the spindle lock mode, as described below with reference to FIG. 6.

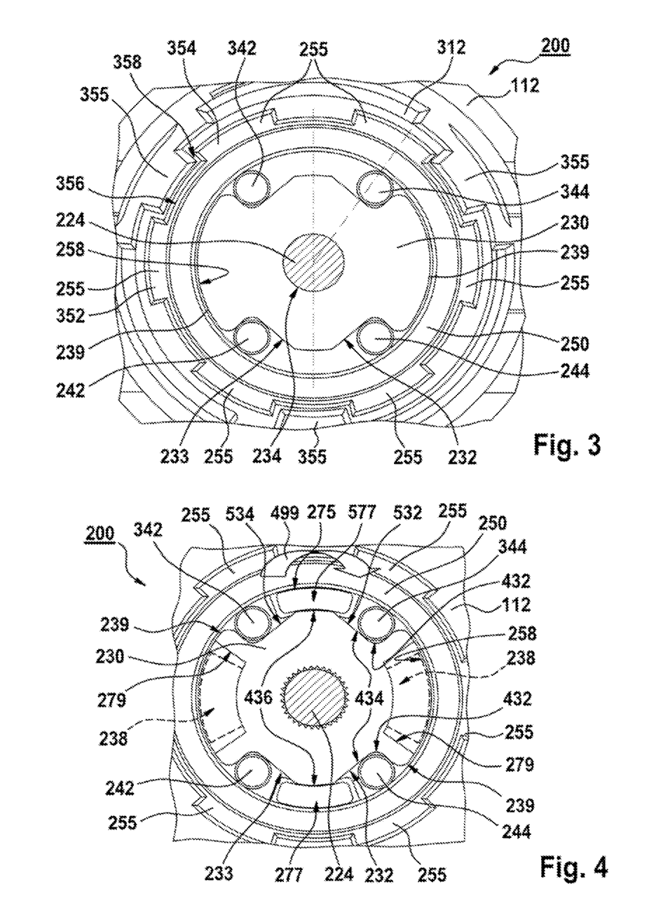

The blocking member 250 is preferably annular in form, and connected to the tool housing 110 of the hand power tool 100 of FIG. 1 in a rotationally fixed manner. By way of illustration, the blocking member 250 is connected to the output housing portion 112 of the tool housing 110. For this purpose, realized on an outer circumference of the blocking member 250 there are a plurality of fastening elements 255, which, by way of illustration, realize holding grooves in the axial direction of the blocking member 250, as described below with reference to FIG. 3.

In an example of mounting of the spindle lock device 200 in the output housing portion 112, an annular washer 260 is preferably first positioned on the second annular shoulder 214, inside the output housing portion 112, and the blocking member 250 is then pushed into the inside of the output housing portion 112, against the first annular shoulder 216 and the annular washer 260. The spindle roller carrier 230 is then disposed on the inner circumference 258 of the blocking member 250, and the connecting portion 224 of the drive spindle 124 is pressed into the opening 234 in the spindle roller carrier 230, from the axial end of the output housing portion 112 that faces toward the annular washer 260. In a further step, the spindle rollers 240 are disposed on the outer circumference of the spindle roller carrier 230, and the coupling member 275 is coupled to the spindle roller carrier 230 in such a manner that its drivers 277 (and 577 in FIG. 3) each space at least two of the spindle rollers 240 apart from each other, and the pin-type driver members 238 of the spindle roller carrier 230 engage in the openings 279 in the coupling member 275. The impact body 272 of the at least one mechanical impact mechanism 170 can then be coupled to the coupling member 275.

FIG. 3 shows the spindle lock device 200 of FIGS. 1 and 2 disposed in the output housing portion 112 of FIGS. 1 and 2, with the blocking member 250, and with spindle roller carrier 230, which is disposed therein and pressed on to the connecting portion 224 of the drive spindle 124, and on the outer circumference of which the spindle rollers 242, 244, and two further spindle rollers 342, 344, are disposed. Each of the spindle rollers 242, 244, 342, 344, in the region of a guide curve assigned to it, is disposed between the spindle roller carrier 230 and the inner circumference 258 of the blocking member 250, e.g. the spindle rollers 242, 244 are disposed in the region of the guide curves 233, 232 of FIG. 2.

According to one embodiment, at least one, and preferably three longitudinal webs 355, for example spaced apart equidistantly from each other, are disposed on the inner circumference 312 of the output housing portion 112. These longitudinal webs, as viewed in the radial direction of the blocking member 250, engage with a predefined play in holding grooves, which are realized, as described with reference to FIG. 2, by the fastening elements 255 provided on the outer circumference of the blocking member 250. For example, two fastening elements, additionally denoted by the references 352, 354, realize a holding groove 356, in which one of the longitudinal webs 355 engages with a predefined play 358. This predefined play 358 allows the blocking member 250 to be automatically aligned with the spindle rollers 242, 244, 342, 344 when the spindle lock device 200 is in the spindle lock mode described with reference to FIG. 6.

FIG. 4 shows the spindle lock device 200 of FIGS. 1 and 2 disposed in the output housing portion 112 of FIGS. 1 and 2, in an exemplary non-operative state, in which the hand power tool 100 of FIG. 1 has been, for example, switched off. In this case the spindle roller carrier 230 of the spindle lock device 200 is represented as partially transparent, so that the pin-type driver members 238 of the spindle roller carrier 230 and the openings 279 in the coupling member 275 of FIG. 2 can be depicted.

FIG. 4 illustrates four guide curves, which are realized, by way of example, on the outer circumference of the spindle roller carrier 230 and comprise the guide curves 232, 233 of FIGS. 2 and 3, as well as two further guide curves 532, 534, bearing on which are the spindle rollers 244, 242 of FIGS. 2 and 344 and 342 of FIG. 3, respectively. Each of the guide curves 232, 233, 532, 534, out from an assigned radial extension 239 of the spindle roller carrier 230, has a seating region, which graduates, via a clamping region, into a transitional region in which the respective guide curve 232, 233, 532 and 534, respectively, graduates into a transitional region of an adjacent guide curve 233, 232, 534 and 532, respectively. By way of illustration, the guide curves 232, 532 have a seating region 432, in which the spindle rollers 244 and 344, respectively, are seated, or blocked, when the hand power tool 100 of FIG. 1 is in the inoperative state and in the normal or impact mode. This seating region 432 graduates into a clamping region 434, the functionality of which is further described below with reference to FIG. 6 and which, in turn, graduates into a transitional region 436, which simultaneously realizes a transitional region of the guide curves 233 and 534, respectively. In the region of the transitional regions 436, the drivers 277 of FIG. 2 and a further driver 577 of the coupling member 275 bear against the outer circumference of the spindle roller carrier 230.

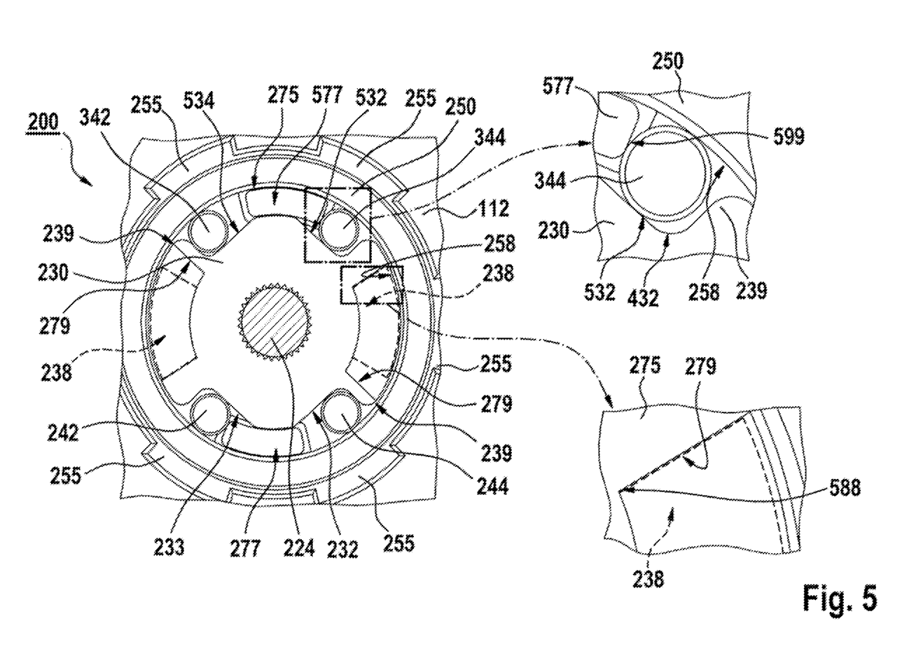

As the result of a driving torque being applied to the spindle roller carrier 230 out from the coupling member 275, e.g. in the direction of an arrow 499, the hand power tool 100 of FIG. 1 can be operated in the normal or impact mode, as described with reference to FIG. 5. As the result of a torque being applied to the spindle roller carrier 230 out from the connecting portion 224 of the drive spindle 124, in the direction of an arrow 499, the hand power tool 100 of FIG. 1 can be operated in the spindle lock mode, as described with reference to FIG. 6.

FIG. 5 shows the arrangement of FIG. 4 when the hand power tool 100 of FIG. 1 is in the normal or impact mode. In this case, a rotation of the coupling member 275 by the impact body 272 of FIG. 2 in the direction of the arrow 499 of FIG. 4 results in a rotation of the spindle roller carrier 230, and therefore of the drive spindle 124 of FIGS. 1 and 2, effecting rotary driving of the pin-type driver members 238 of the spindle roller carrier 230, which engage in the openings 279 in the coupling member 275, by the coupling member 275, via an assigned driver face 588, as shown in an enlarged detail view.

According to one embodiment, in the case of the rotary driving of the spindle roller carrier 230, the coupling member 275 is rotated relative to the latter in such a manner that the drivers 277, 577 block at least one, and preferably two, of the spindle rollers 242, 244, 342, 344 in the seating regions of their assigned guide curves 233, 232, 534 and 532, respectively. For example, the driver 577 blocks the spindle roller 344 in the seating region 432 of the guide curve 532 by means of a blocking face 599. At least one, and preferably two, more of the spindle rollers 242, 244, 342, 344 are blocked in the seating regions of their assigned guide curves 233, 232, 534 and 532, respectively, by the rotation of the spindle roller carrier 230. In FIG. 5, these are the spindle rollers 244, 342. The spindle roller carrier 230 can thus be rotated in the blocking member 250, the spindle rollers 242, 244, 342, 344 rolling on the inner circumference 258 of the latter.

FIG. 6 shows the arrangement of FIG. 4 when the hand power tool 100 of FIG. 1, or the spindle lock device 200 of FIGS. 1 to 5, is in the spindle lock mode. In this case, a rotation of the spindle roller carrier 230 by the connecting portion 224, or the drive spindle 124, of FIGS. 1 and 2, relative to the coupling member 275 results, at least, in at least one, and preferably two, of the spindle rollers 242, 244, 342, 344 rolling along their assigned guide curves 233, 232, 534 and 532, respectively, on the inner circumference 258 of the blocking member 250, such that said spindle rollers become blocked, or clamped, in the clamping region of the respective guide curve 233, 232, 534 and 532, respectively, between the spindle roller carrier 230 and the blocking member 250. By way of illustration, the spindle roller 344 is clamped in the clamping region 434 of the guide curve 532, as shown in an enlarged detail view. A rotation of the spindle roller carrier 230 relative to the blocking member 250, and thus of the drive spindle 124 of FIGS. 1 and 2 relative to the tool housing 110 of FIG. 1, can thus be prevented. In this case, the rotation of the spindle roller carrier 230 relative to the coupling member 275 can be effected until the pin-type driver members 238 of the spindle roller carrier 230 engaging in the openings 279 in the coupling member 275 bear against an assigned holding face 699 in the openings 279.

What is claimed is:

1. A hand power tool, comprising:
a drive spindle;
a mechanical impact mechanism including an impact body having at least two drive cams; and
a spindle lock device including a spindle roller carrier disposed on the drive spindle and on which at least two spindle rollers are disposed,
wherein the spindle lock device is connected via a coupling member to the mechanical impact mechanism,
wherein the coupling member is disposed between the impact body and the spindle roller carrier in an axial direction of the drive spindle, and
wherein the coupling member is configured to effect rotary driving of the spindle roller carrier, upon rotary driving by the impact body, when the hand power tool is in a normal mode.

2. The hand power tool according to claim 1, wherein the coupling member has at least two output cams configured to be driven percussively by the drive cams of the impact body when the mechanical impact mechanism is in an impact mode.

3. The hand power tool according to claim 1, wherein:
the coupling member has at least one opening, and
the spindle roller carrier has a pin-type driver member configured to engage the at least one opening to enable rotary driving of the spindle roller carrier upon rotary driving of the coupling member by the impact body when the hand power tool is in the normal mode.

4. The hand power tool according to claim 1, wherein:
the coupling member has at least two drivers disposed on an outer circumference of the spindle roller carrier,
the at least two drivers enable at least one of the at least two spindle rollers to be driven upon rotary driving of the spindle roller carrier by the coupling member when the hand power tool is in the normal mode.

5. The hand power tool according to claim 1, wherein the spindle roller carrier is disposed on the drive spindle in a rotationally fixed manner.

6. The hand power tool according to claim 1, wherein:
the spindle roller carrier with the at least two spindle rollers is seated so as to be rotationally movable in a blocking member, and
the blocking member is configured to fix the at least two spindle rollers to the spindle roller carrier in a radial direction of the drive spindle.

7. The hand power tool according to claim 4, wherein, on the outer circumference, the spindle roller carrier has an assigned guide curve for each of the at least two spindle rollers.

8. The hand power tool according to claim 7, wherein the assigned guide curve is configured to enable at least one spindle roller to be clamped between the spindle roller carrier and the blocking member when the spindle lock device is in a spindle lock mode.

9. The hand power tool according to claim 8, wherein the spindle lock device has at least four spindle rollers and, when the spindle lock device is in the spindle lock mode, at least two of the at least four spindle rollers in each case prevent a rotation of the spindle roller carrier relative to the blocking member.

10. The hand power tool according to claim 6, wherein the blocking member is annular and is connected to a tool housing of the hand power tool in a rotationally fixed manner.
